(19) United States
(12) Patent Application Publication
(10) Pub. No.: US 2023/0196942 A1
(43) Pub. Date: Jun. 22, 2023

(54) INPUT APPARATUS AND CONTROL METHOD THEREOF

(71) Applicant: TOSHIBA TEC KABUSHIKI KAISHA, Tokyo (JP)

(72) Inventors: Kazuki SATO, Mishima (JP); Naoki SEKINE, Mishima (JP); Shogo WATADA, Numazu (JP); Yuko KIMOTO, Tokyo (JP)

(73) Assignee: TOSHIBA TEC KABUSHIKI KAISHA, Tokyo (JP)

(21) Appl. No.: 17/833,732

(22) Filed: Jun. 6, 2022

(30) Foreign Application Priority Data
Dec. 21, 2021 (JP) 2021-206953

(51) Int. Cl. G09B 21/00; G06F 3/02; G06F 3/041; G06F 3/16

(52) U.S. Cl. CPC G09B 21/003; G06F 3/0219; G06F 3/0412; G06F 3/167

(57) ABSTRACT

An input apparatus includes a touch panel and a processor. The touch panel is configured to receive a first input of giving a first instruction that a dot configuring a braille character corresponds to a dotted protrusion through a first operation and a second input of giving a second instruction different from the first instruction of the first input through a second operation different from the first operation. The processor is configured to identify the braille character based on the first input and the second input received by the touch panel and searches for one or more process functions corresponding to the braille character identified by the processor.

### CROSS-REFERENCE TO RELATED APPLICATION

This application is based upon and claims the benefit of priority from Japanese Patent Application No. 2021-206953, filed on Dec. 21, 2021, the entire contents of which are incorporated herein by reference.

### FIELD

Embodiments described herein relate generally to an input apparatus and a control method thereof.

### BACKGROUND

An input apparatus such as a digital multi-functional peripheral (MFP) includes, for example, a touch panel that receives a touch input operation of a user. In the related art, the touch panel includes dotted protrusion correspondences configuring characters for visually impaired persons, that is, so-called braille characters that are read by touch of fingertips.

### DESCRIPTION OF THE DRAWINGS

FIG. 1 is a schematic diagram illustrating an example of 6-dot Braille;

FIG. 2 is a schematic diagram illustrating an example of braille characters representing hiragana characters;

FIG. 3 is a block diagram schematically illustrating a configuration example of an input apparatus according to at least one embodiment;

FIG. 4 is a schematic diagram illustrating an example of a data structure of a braille file;

FIG. 5 is a schematic diagram illustrating an example of a data structure of a process name table;

FIG. 6 is a flowchart illustrating a procedure of information processing that is executed by a processor of a control system;

FIG. 7 is a flowchart illustrating a procedure of the information processing that is executed by the processor of the control system; and

FIG. 8 is a schematic diagram illustrating an example of a screen transition of an n-th braille input screen.

### DETAILED DESCRIPTION

In input apparatuses such as those described above, for the visually impaired persons, it is difficult to read various kinds of information displayed on the touch panel and to execute an input operation.

An object to be solved by embodiments is to provide an input apparatus that has a dotted protrusion correspondence function configuring a braille character and a control method thereof.

In general, according to at least one embodiment, an input apparatus includes a touch panel and a processor. The touch panel receives a first input of giving an instruction that a dot configuring a braille character corresponds to a dotted protrusion through a first operation and a second input of giving an instruction different from the instruction of the first input through a second operation different from the first operation. The processor identifies the braille character based on the first input and the second input received by the touch panel and searches for a process function corresponding to the identified braille character.

Hereinafter, an embodiment will be described in detail with reference to the drawings. In the embodiment, a user as a visually impaired person uses an input apparatus 1 with Braille. The visually impaired person has a disability in, for example, vision or visual field.

Before describing the input apparatus 1, Braille will be described.

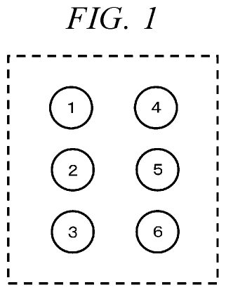

FIG. 1 is a schematic diagram illustrating an example of 6-dot Braille. Braille characters are characters for visually impaired persons that are read by touch of fingertips. A visually impaired person is an example of a user. 6-dot Braille is Braille configured with six dots (horizontal 2×vertical 3), which are called “dot 1”, “dot 2”, and “dot 3” in order from the upper left dot to the lower left dot and called “dot 4”, “dot 5”, and “dot 6” in order from the upper right dot to the lower right dot. “Dot 1” to “dot 6” represent the numbers of the dots. For example, “dot 1” can also be referred to as the first dot. 6-dot Braille is an example of Braille. In the description of the present embodiment, it is assumed that Braille is 6-dot Braille. One character is represented by whether or not each of dots configuring a braille character corresponds to a dotted protrusion. Characters are, for example, hiragana characters, numerical characters, alphabets, or characters of a language other than Japanese. In the present embodiment, it is assumed that characters are hiragana characters.

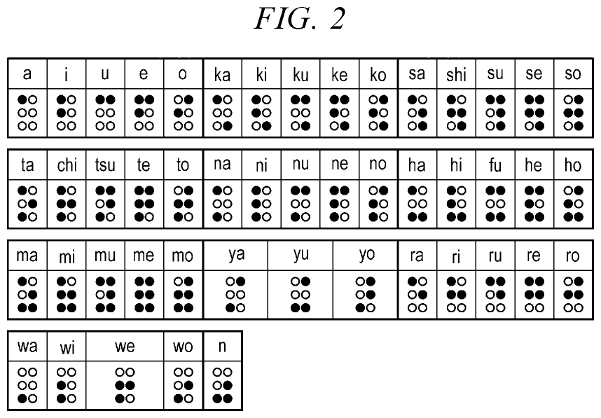

FIG. 2 is a schematic diagram illustrating an example of braille characters representing hiragana characters. As illustrated in FIG. 2, for example, a braille character representing “a” is represented by “dot 1” as a black circle and “dot 2” to “dot 6” as white circles. The black circle represents a dot corresponding to a dotted protrusion. The white circle represents a dot not corresponding to a dotted protrusion. That is, the braille character representing “a” is configured with “dot 1” corresponding to a dotted protrusion and “dot 2” to “dot 6” not corresponding to dotted protrusions. The dot corresponding to a dotted protrusion can also be referred to as a dot having a dotted protrusion. The dot not corresponding to a dotted protrusion can also be referred to as a dot not having a dotted protrusion.

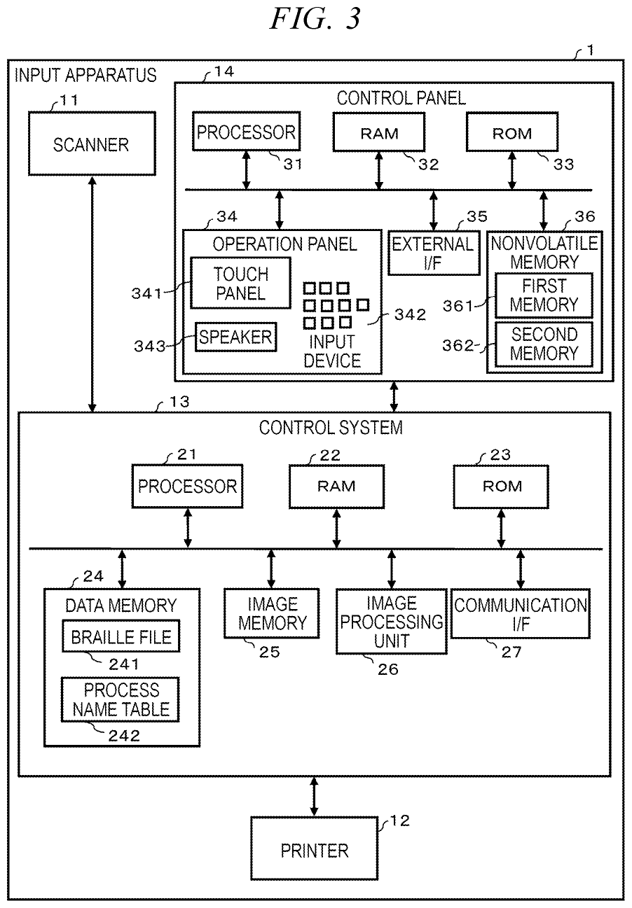

FIG. 3 is a block diagram schematically illustrating a configuration example of the input apparatus 1 according to the embodiment. In the present embodiment, it is assumed that the input apparatus 1 is an MFP.

The input apparatus 1 includes a scanner 11, a printer 12, a control system 13, and a control panel 14. In addition, the scanner 11, the printer 12, and the control panel 14 are connected to the control system 13.

The scanner 11 optically reads an image of a document and converts the read image into image data. The scanner 11 scans a document in accordance with an operation instruction from the control system 13. The scanner 11 outputs the image data of the read document to the control system 13. The scanner 11 may be, for example, an optical reduction type including an imaging element such as a charge-coupled device (CCD) image sensor, may be a contact image sensor (CIS) type including an imaging element such as a complementary metal-oxide-semiconductor (CMOS) image sensor, or may be another well-known type.

The printer 12 forms an image on an image formed medium. The image formed medium is, for example, paper or a resin film. The printer 12 prints an image based on the image data supplied from the control system 13 on the image formed medium under various printing conditions designated by the control system 13. The input apparatus 1 prints a document read by the scanner 11 on the image formed medium to copy the document. As the printer 12, various image forming types of printers can be adopted. The printer 12 may be, for example, an electrophotographic printer or may be an ink jet type or a thermal transfer type.

The control system 13 integrally controls the entire input apparatus 1. The control system 13 is connected to each of the components in the input apparatus 1 such as the scanner 11, the printer 12, or the control panel 14. The control system 13 communicates bidirectionally with the scanner 11, the printer 12, and the control panel 14. The control system 13 integrally controls operations of the components such as the scanner 11, the printer 12, or the control panel 14. In addition, the control system 13 executes various processing such as image processing.

The control system 13 includes a processor 21, a random-access memory (RAM) 22, a read only memory (ROM) 23, a data memory 24, an image memory 25, an image processing unit 26, and a communication interface (communication I/F) 27. The processor 21, the RAM 22, the ROM 23, and the data memory 24 control the components and execute various processing.

The processor 21 executes processes such as arithmetic operations or controls in accordance with programs. The processor 21 is, for example, a central processing unit (CPU). The processor 21 implements various process functions by executing programs stored in the ROM 23 or the data memory 24. The RAM 22 is a working memory. The RAM 22 is, for example, a volatile memory. The RAM 22 reads a program to be executed or functions as a buffer memory. The ROM 23 is a program memory. The ROM 23 is, for example, an unrewritable non-volatile memory. The ROM 23 stores a program, setting data, and the like unique to the input apparatus 1.

The data memory 24 stores control data, a control program, setting information, and the like. The data memory 24 is, for example, a rewritable non-volatile memory. The data memory 24 also stores, for example, default set values in various operation modes.

The image memory 25 is configured with a page memory or the like. The image memory 25 stores image data. The image processing unit 26 executes image processing on image data.

The communication interface 27 is a network interface that executes data communication with an external apparatus via a network such as the Internet.

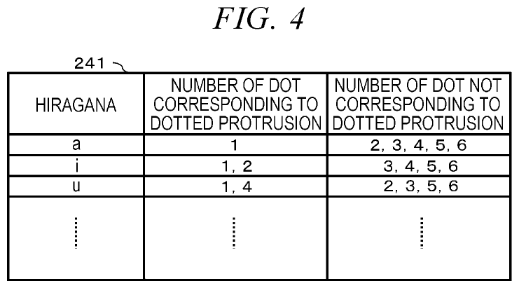

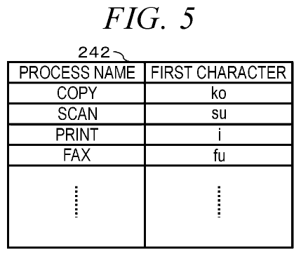

The data memory 24 includes a braille file 241 (refer to FIG. 4) and a process name table 242 (refer to FIG. 5). The braille file 241 and the process name table 242 may be provided for each input apparatus 1. The braille file 241 and the process name table 242 may be stored in a memory of an external apparatus capable of communicating with the input apparatus 1. The braille file 241 and the process name table 242 may be provided in a memory of a server apparatus capable of communicating via the communication interface 27 or may be provided in a memory of another input apparatus capable of communicating via the communication interface 27.

FIG. 4 is a schematic diagram illustrating an example of a data structure of the braille file 241. As illustrated in FIG. 4, the braille file 241 is a data file in which a hiragana character, the numbers of dots corresponding to dotted protrusions, and the numbers of dots not corresponding to dotted protrusions are correlated with each other and stored. The number of a dot corresponding to a dotted protrusion is the number of a dot corresponding to a dotted protrusion that configures a braille character representing the corresponding hiragana character. The number of a dot not corresponding to a dotted protrusion is the number of a dot not corresponding to a dotted protrusion that configures a braille character representing the corresponding hiragana character. For example, the braille character representing “a” is configured with “dot 1” corresponding to a dotted protrusion and “dot 2” to “dot 6” not corresponding to dotted protrusions. Therefore, in FIG. 4, “1” is stored in the number of a dot corresponding to a dotted protrusion, and “2” to “6” are stored in the number of a dot not corresponding to a dotted protrusion, with respect to “a”. The items displayed in FIG. 4 are not limited to this. Other items may be displayed. The contents of the items displayed in FIG. 4 are merely examples.

FIG. 5 is a schematic diagram illustrating an example of a data structure of the process name table 242. As illustrated in FIG. 5, the process name table 242 is a data table configured with a process name and a first character. The process name is a name of a process function of the input apparatus 1. Examples of the process name include “copy”, “scan”, “print”, and “fax”. The process function is an example of a process function corresponding to an identified braille character. The first character is a first hiragana character if the process name is expressed by hiragana characters. The first character is an example of a character correlated with the name of the process function. In the present embodiment, it is assumed that the process name and the first character have a one-to-one relationship. In FIG. 5, for example, the first character corresponding to “copy” is “ko”. For example, the first character corresponding to “scan” is “su”. The items displayed in FIG. 5 are not limited to this. Other items may be displayed. The contents of the items displayed in FIG. 5 are merely examples.

Referring back to FIG. 3, the description will be made.

The control panel 14 is a user interface. The control panel 14 displays a guidance to the user or receives an operation instruction of the user. The control panel 14 includes a processor 31, a RAM 32, a ROM 33, an operation panel 34, an external interface (external I/F) 35, and a non-volatile memory 36.

The processor 31 controls the control panel 14. The processor 31 is an arithmetic circuit that executes a program. The processor 31 is, for example, a CPU. The processor 31 implements various process functions by executing programs stored in the ROM 33. The processor 31 supplies information input to the components of the control panel 14 to the control system 13. In addition, the processor 31 controls each of the components in the control panel 14 in accordance with a control signal from the control system 13.

The RAM 32 is a working memory. The RAM 32 is, for example, a volatile memory. The ROM 33 is a non-volatile program memory. The ROM 33 may be configured with, for example, a rewritable non-volatile memory such that a program, control data, setting information, display data, and the like can be updated.

The operation panel 34 is a user interface. The operation panel 34 includes, for example, a touch panel 341, an input device 342, and a speaker 343.

In the touch panel 341, for example, a display such as a liquid crystal display or an organic electro-luminescence (EL) display and a sensing device that detects a touch input are stacked. The touch panel 341 has a flat surface and does not enter a protrusion state. The touch panel 341 is an example of a display that displays various process functions. The display in the touch panel 341 displays a screen for notifying various kinds of information to the user. The touch panel 341 receives a touch input operation of the user. The touch input operation is, for example, an operation of touching various text information or image information displayed on the touch panel 341 with a finger, a touch pen, or the like. Examples of the touch input operation include a tap operation, a double tap operation, a long tap operation, a swipe operation, a pinch out operation, and a pinch in operation. The tap operation is, for example, an operation of tapping various text information or image information displayed on the touch panel 341 with a finger, a touch pen, or the like. The double tap operation is, for example, an operation of performing the tap operation continuously twice. The long tap operation is, for example, an operation of long-pressing various text information or image information displayed on the touch panel 341 with a finger, a touch pen, or the like. The swipe operation is, for example, an operation of sliding a finger in a given direction while touching a display screen displayed on the touch panel 341 with the finger. Examples of the given direction include a left direction, a right direction, an upward direction, and a downward direction. The pinch out operation is, for example, an operation of spreading two fingers while touching the display screen with the fingers. The pinch in operation is, for example, an operation of narrowing two fingers while touching the display screen with the fingers. Examples of the touch input operation include a tap operation, a double tap operation, a long tap operation, and a swipe operation using a plurality of fingers. The touch input operation is an example of the first operation. The touch input operation is an example of the second operation. The second operation is an operation different from the first operation.

The processor 31 detects the content of an operation instruction, for example, in accordance with the touch input operation of the user on the display screen that is detected by the touch panel 341. The processor 31 supplies information representing the content of the detected operation instruction to the processor 21 of the control system 13. The processor 31 causes the touch panel 341 to display various display screens in accordance with the instruction from the processor 21. The touch panel 341 supplies, for example, a position touched by the user or a swipe direction to the processor 31 as a detection signal.

The input device 342 receives the operation of the user. Examples of the input device 342 include a button, a keyboard, a key pad, or a touch pad. Examples of the button include an execution button.

The speaker 343 is an output device for outputting sound data. Examples of the sound data include a sound and a voice. The speaker 343 outputs a voice guidance relating to a determination of the searched process function.

The external interface 35 is an interface for connection to an external apparatus. The external interface 35 can be configured as an interface based on a universal standard such as a universal serial bus (USB). The external interface 35 may be connected to, for example, a portable storage device or may be connected to, for example, a numeric keypad or a portable keyboard.

The non-volatile memory 36 is a rewritable memory. The non-volatile memory 36 stores, for example, information on the touch input operation in the touch panel 341. The non-volatile memory 36 includes a first memory 361 and a second memory 362. The first memory 361 stores the number of a dot corresponding to a dotted protrusion. The second memory 362 stores the number of a dot not corresponding to a dotted protrusion.

The processor 21 of the control system 13 will be described.

The processor 21 identifies the braille character based on the first input and the second input received by the touch panel 341 and searches for a process function corresponding to the identified braille character.

If the second input is received, the processor 21 confirms whether or not the dot configuring the braille character corresponds to a dotted protrusion, and if a number of times the processor 21 confirms whether or not the dot configuring the braille character corresponds to a dotted protrusion reaches a predetermined number of times, the processor 21 has a function of identifying the braille character.

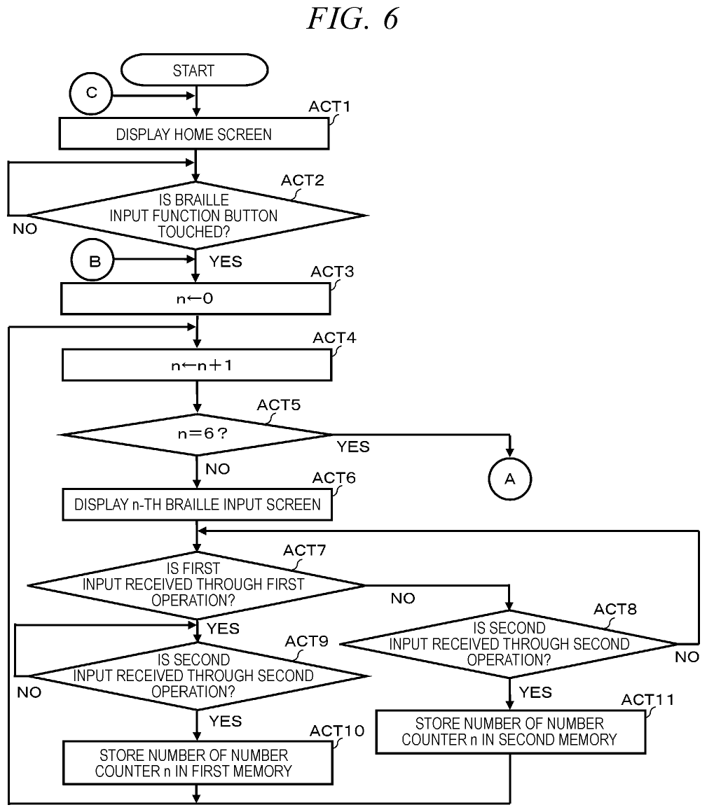

FIG. 6 is a flowchart illustrating a procedure of information processing that is executed by the processor 21 of the control system 13 of the input apparatus 1. Hereinafter, the operation of the input apparatus 1 will be described using the flowchart. The operation described below is an example. As long as the same result can be obtained, the procedure is not particularly limited.

In ACT 1, the processor 21 of the control system 13 causes the touch panel 341 of the control panel 14 to display a home screen. The home screen is, for example, a screen where various process function buttons can be selected. The home screen includes, for example, a copying function button, a scanning function button, a printing function button, a fax function button, and a braille input function button. The braille input function includes, for example, an operation for allowing the user to input a braille character. The processor 21 receives various operation instructions on the display screen that are detected by the touch panel 341.

In the present embodiment, for example, if the user inputs an operation by performing a predetermined touch input operation on the display screen displayed on the touch panel 341 or if the user inputs a predetermined button of the input device 342, the user can give an instruction to start or stop the voice guidance. The voice guidance guides, for example, various kinds of information displayed on the touch panel 341 with voice. The various kinds of information include, for example, positional information of various process function buttons on the home screen. For example, if the input of starting the voice guidance through the predetermined operation is received, the processor 21 causes the speaker 343 to output the voice guidance. For example, if the braille input function button is selected, the processor 21 may cause the speaker 343 to output the voice guidance.

In ACT 2, the processor 21 determines whether or not the braille input function button is touched. If the braille input function button is touched, the processor 21 determines YES in ACT 2, and the process proceeds to ACT 3.

In ACT 3, the processor 21 initializes a value n of a number counter to “0”. In ACT 4, the processor 21 counts up the number counter n by “1”. In ACT 5, the processor 21 determines whether or not the number counter n is “6”. If the number counter n is 6, one hiragana character is configured. For example, in the case of a character of a language other than Japanese, the number counter n may change depending on the language.

If the number counter n is not “6”, the processor 21 determines NO in ACT 5 and proceeds to ACT 6.

In ACT 6, the processor 21 causes the touch panel 341 to display an n-th braille input screen. The n-th braille input screen is, for example, a screen for allowing the user to instruct whether or not each of the six dots configuring a braille character corresponds to a dotted protrusion. The n-th braille input screen is, for example, a screen for allowing the user to input a braille character representing a character correlated with the name of a process function to be used. “n” represents the number of the number counter n acquired in the process of ACT 4.

In ACT 7 and ACT 8, the processor 21 waits for receiving the first input through the first operation and the second input through the second operation.

In the present embodiment, the first operation is the tap operation on the n-th braille input screen displayed on the touch panel 341. The first operation is an operation for giving an instruction that a dot configuring a braille character corresponds to a dotted protrusion. The operation input for giving an instruction that a dot configuring a braille character corresponds to a dotted protrusion through the tap operation is an example of the first input of giving an instruction that a dot configuring a braille character corresponds to a dotted protrusion through the first operation on the touch panel 341. The first input through the first operation can also be referred to as the operation input for giving an instruction that a dot configuring a braille character corresponds to a dotted protrusion through the tap operation.

In the present embodiment, the second operation is the swipe operation on the n-th braille input screen displayed on the touch panel 341. The swipe operation is performed consistently in a predetermined direction. The second operation is an operation for giving an instruction different from that of the first input. The second operation is an operation of confirming whether or not the dot configuring the braille character corresponds to a dotted protrusion. The operation input for giving an instruction to confirm whether or not the dot configuring the braille character corresponds to a dotted protrusion through the swipe operation is an example of the second input of giving an instruction different from the instruction of the first input through the second operation different from the first operation. The second input through the second operation can also be referred to as the operation input for giving an instruction to confirm whether or not the dot configuring the braille character corresponds to a dotted protrusion through the swipe operation.

If the first input is received through the first operation in the waiting state of ACT 7 and ACT 8, the processor 21 determines YES in ACT 7 and proceeds to ACT 9.

In ACT 9, the processor 21 determines whether or not the second input is received through the second operation. If the second input is received through the second operation, the processor 21 determines YES in ACT 9 and proceeds to ACT 10.

In ACT 10, the processor 21 stores the number of the number counter n in the first memory 361 of the non-volatile memory 36. The number of the number counter n stored in the first memory 361 refers to the number of the dot corresponding to a dotted protrusion. The processor 21 proceeds to ACT 4.

If the second input is received through the second operation in the waiting state of ACT 7 and ACT 8, the processor 21 determines YES in ACT 8 and proceeds to ACT 11.

In the present embodiment, the second operation may also be an operation for giving an instruction that the dot configuring the braille character does not correspond to a dotted protrusion. The operation input for giving an instruction that the dot configuring the braille character does not correspond to a dotted protrusion through the swipe operation is an example of the second input of giving an instruction different from the instruction of the first input through the second operation different from the first operation. The second input through the second operation can also be referred to as the operation input for giving an instruction that the dot configuring the braille character does not correspond to a dotted protrusion through the swipe operation. For example, the first input may be the operation input for giving an instruction that a dot configuring a braille character does not correspond to a dotted protrusion.

In ACT 11, the processor 21 stores the number of the number counter n in the second memory 362 of the non-volatile memory 36. The number of the number counter n stored in the second memory 362 refers to the number of the dot not corresponding to a dotted protrusion. The processor 21 proceeds to ACT 4.

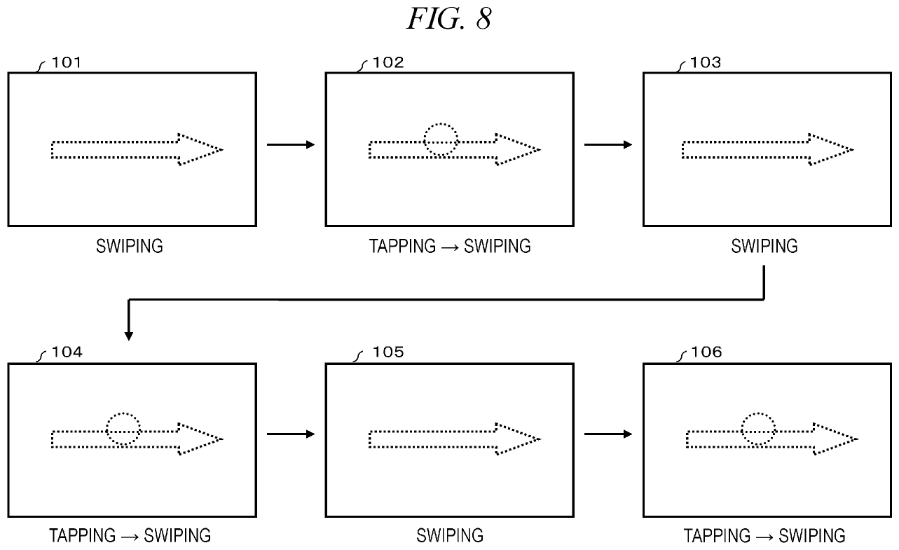

Here, a specific example of the operation input to the n-th braille input screen will be described using FIG. 8.

FIG. 8 is a schematic diagram illustrating an example of a screen transition of the n-th braille input screen. FIG. 8 illustrates a case where, if the user uses the copying function as the process function, a braille character representing “ko” as the first character corresponding to “copy” is input to the n-th braille input screen. The braille character representing “ko” is configured with “dot 2”, “dot 4”, and “dot 6” corresponding to dotted protrusions and “dot 1”, “dot 3”, and “dot 5” not corresponding to dotted protrusions.

First, if the processor 21 causes the touch panel 341 to display a first braille input screen 101, the user designates whether or not “dot 1” corresponds to a dotted protrusion. Since “dot 1” does not correspond to a dotted protrusion, the user performs the operation input through the swipe operation as the second input through the second operation. In FIG. 8, a state where the first braille input screen 101 is swiped in the right direction is schematically illustrated by an arrow of a two-dot chain line. If the second input is received through the second operation, the processor 21 confirms that “dot 1” is a dot not corresponding to a dotted protrusion. The processor 21 stores “1” in the second memory 362 and causes the touch panel 341 to display a second braille input screen 102. The user designates whether or not “dot 2” corresponds to a dotted protrusion. Since “dot 2” corresponds to a dotted protrusion, the user performs the operation input through the tap operation as the first input through the first operation and subsequently performs the second input through the second operation. In FIG. 8, a state where the second braille input screen 102 is tapped is schematically illustrated by a circle of a two-dot chain line. If the second input is received through the second operation, the processor 21 confirms that “dot 2” is a dot corresponding to a dotted protrusion. The processor 21 stores “2” in the first memory 361 and causes the touch panel 341 to display a third braille input screen 103. Next, the same process as that of “dot 1” is performed on the third braille input screen 103 and a fifth braille input screen 105, and the same process as that of “dot 2” is performed on a fourth braille input screen 104 and a sixth braille input screen 106. In this way, the user designates and confirms whether or not each of the dots configuring the braille character representing “ko” corresponds to a dotted protrusion. FIG. 8 exemplifies the operation input through the swipe operation in the right direction. The swipe direction may be a left direction, an upward direction, or a downward direction. The swipe operation only needs to be performed consistently in a predetermined direction.

In addition, while the user is performing the operation input to the n-th braille input screen, the processor 21 may cause the speaker 343 to output the voice guidance. The voice guidance is, for example, “The n-th braille input screen is displayed. Please input an operation.”

Referring back to FIG. 6, the description will be made.

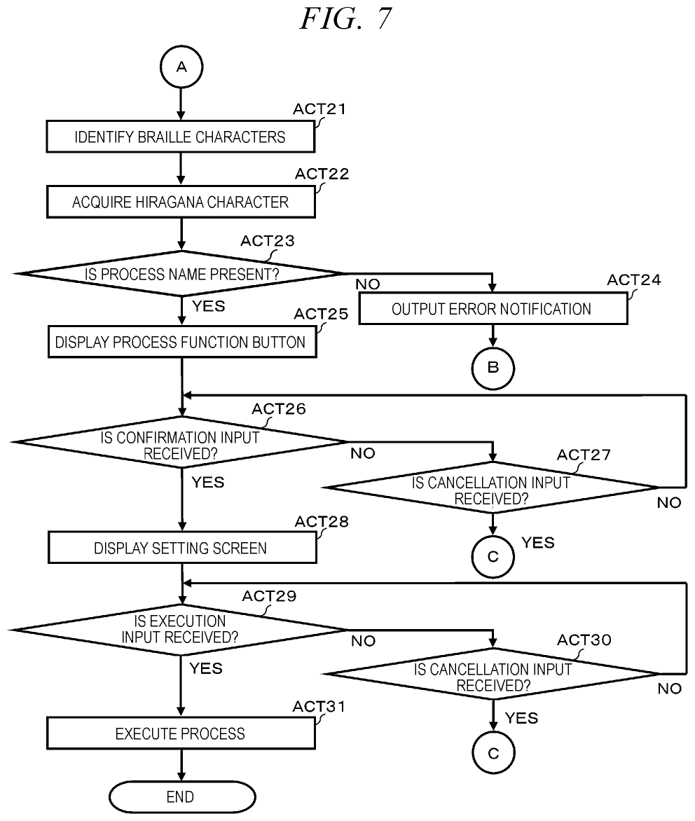

If the number counter n is “6”, the processor 21 determines YES in ACT 5 and proceeds to ACT 21 of FIG. 7. “6” is an example of the predetermined number of times.

In ACT 21, the processor 21 identifies the braille character based on the numbers stored in the first memory 361 and the second memory 362 of the non-volatile memory 36. In ACT 22, the processor 21 acquires a hiragana character based on the braille character identified with reference to the braille file 241 stored in the data memory 24.

For example, if “2”, “4”, and “6” are stored in the first memory 361 of the non-volatile memory 36 and “1”, “3”, and “5” are stored in the second memory 362 of the non-volatile memory 36, the processor 21 identifies a braille character that is configured with “dot 2”, “dot 4”, and “dot 6” corresponding to dotted protrusions and “dot 1”, “dot 3”, and “dot 5” not corresponding to dotted protrusions. The processor 21 acquires “ko” as one hiragana character correlated with the braille character that is configured with “dot 2”, “dot 4”, and “dot 6” corresponding to dotted protrusions and “dot 1”, “dot 3”, and “dot 5” not corresponding to dotted protrusions with reference to the braille file 241.

In ACT 23, the processor 21 searches for whether or not a process name correlated with the acquired hiragana character is present with reference to the process name table 242 stored in the data memory 24.

If the process name correlated with the acquired hiragana character is not present, the processor 21 determines NO in ACT 23 and proceeds to ACT 24.

In ACT 24, the processor 21 causes the speaker 343 to output an error notification. The error notification only needs to be, for example, the content that notifies that the process function cannot be found based on the input braille character. The error notification may be, the content that notifies that the first braille input screen is displayed again. The processor 21 proceeds to ACT 3 of FIG. 6.

If the process name correlated with the acquired hiragana character is present, the processor 21 determines YES in ACT 23 and proceeds to ACT 25.

In ACT 25, the processor 21 causes the touch panel 341 to display a process function button of the corresponding process name. For example, the processor 21 may cause the touch panel 341 to display the home screen, may enable the process function button of the corresponding process name, and may disable the process function button of the non-corresponding process name. The process function button of the corresponding process name is an example of the process function result.

In addition, the processor 21 causes the speaker 343 to output the voice guidance. The voice guidance is, for example, “If the copying function is determined, please input determination through a determination operation. If the copying function is cancelled, please input cancellation through a cancellation operation”. The determination input through the determination operation and the cancellation input through the cancellation operation will be described below.

In ACT 26 and ACT 27, the processor 21 waits for receiving the determination input through the determination operation and the cancellation input through the cancellation operation.

The determination operation is an operation for instructing to determine the process function of the corresponding process name. As the determination operation, for example, the user may touch the process function button of the corresponding process name or may perform a predetermined touch input operation on the touch panel 341. As the predetermined touch input operation, for example, if the user performs the double tap operation on the touch panel 341, the processor 21 may determine that the determination input is received.

The cancellation operation is an operation for instructing to cancel the determination of the process function of the corresponding process name. As the cancellation operation, for example, the user may perform a predetermined touch input operation on the touch panel 341. As the predetermined touch input operation, for example, if the user performs the double tap operation on the touch panel 341 using a plurality of fingers, the processor 21 may determine that the cancellation input is received.

The user may set the determination operation and the cancellation operation in advance. If the determination input and the cancellation input are received through the touch input operation, the determination operation and the cancellation operation only need to be different touch input operations.

If the cancellation input is received through the cancellation operation in the waiting state of ACT 26 and ACT 27, the processor 21 determines YES in ACT 27 and proceeds to ACT 1 of FIG. 6.

If the determination input is received through the determination operation in the waiting state of ACT 26 and ACT 27, the processor 21 determines YES in ACT 26 and proceeds to ACT 28.

In ACT 28, the processor 21 causes the touch panel 341 to display a setting screen of the process function of the corresponding process name. The setting screen is, for example, a screen for allowing the user to give an instruction for various detailed settings relating to the process function. For example, various detailed settings relating to the copying function include a color mode, a density, paper, duplex printing or simplex printing, the number of copies, and the direction of a document. For example, various detailed settings relating to the scanning function include a destination, a color mode, and a resolution. The setting screen may include an execution button. The execution button is, for example, a button for allowing the user to instruct to execute the process of the process function.

In addition, the processor 21 may cause the speaker 343 to output the voice guidance. The voice guidance is, for example, “The setting screen of the copying function is displayed. As various detailed settings relating to the copying function, a color mode, a density, paper, duplex printing or simplex printing, the number of copies, the direction of a document, and the like can be set.”

In ACT 29 and ACT 30, the processor 21 waits for receiving an execution input through an execution operation and a cancellation input through a cancellation operation.

The execution operation is, for example, an operation for instructing to execute the process of the determined process function. As the execution operation, for example, the user may input an execution button of the input device 342, may touch an execution button displayed on the setting screen, or may perform a predetermined touch input operation on the touch panel 341. As the predetermined touch input operation, for example, if the user performs the double tap operation on the touch panel 341, the processor 21 may determine that the execution input is received.

The user may set the execution operation in advance. If the execution input and the cancellation input are performed through the touch input operation, the execution operation and the cancellation operation only need to be different touch input operations.

If the cancellation input is received through the cancellation operation in the waiting state of ACT 29 and ACT 30, the processor 21 determines YES in ACT 30 and proceeds to ACT 1 of FIG. 6.

If the execution input is received through the execution operation in the waiting state of ACT 29 and ACT 30, the processor 21 determines YES in ACT 29 and proceeds to ACT 31.

In ACT 31, the processor 21 executes the process of the determined process function. For example, in the case of the copying function, the processor 21 executes the copying process. For example, in the case of the scanning function, the processor 21 executes the scanning process. These processes are already known, and thus specific description thereof will not be made. Hereinabove, the processor 21 ends the information processing of the procedures illustrated in the flowcharts of FIGS. 6 and 7.

As described above, in the input apparatus 1, if the braille input function button is touched, the processor 21 of the control system 13 causes the touch panel 341 to display the n-th braille input screen. On the n-th braille input screen, the processor 21 waits for receiving the first input of giving an instruction that a dot configuring a braille character corresponds to a dotted protrusion through the first operation and the second input of giving an instruction different from the instruction of the first input through the second operation different from the first operation. The processor 21 identifies the braille character based on the first input received through the first operation and the second input received through the second operation. The processor 21 searches for whether or not a process name correlated with the identified braille character is present.

As a result, the user can input the braille character on the touch panel 341. The user can search for the process function to be used by simply performing the two types of input operations including the first operation and the second operation on the touch panel 341. Therefore, it is easy to perform the input operation. In addition, a configuration for visually impaired persons, for example, dotted protrusion correspondence does not need to be newly provided in the input apparatus 1, and the investment for facilities can be reduced.

If the second input is received through the second operation on the n-th braille input screen after receiving the first input through the first operation, the processor 21 confirms that the n-th dot configuring the braille character is a dot corresponding to a dotted protrusion. If the second input is received through the second operation, the processor 21 confirms that the n-th dot configuring the braille character is a dot not corresponding to a dotted protrusion. In this way, if the number of times of the confirmation reaches a predetermined number of times, the braille character is identified.

As a result, the user can designate and confirm whether or not each of the dots configuring the braille corresponds to a dotted protrusion on the touch panel 341. The user only needs to perform the two types of input operations including the first operation and the second operation. Therefore, it is easy to perform the input operation.

The processor 21 causes the touch panel 341 to display the process function result.

As a result, the user can search for the process function result without repeating a complex input operation by simply performing the two types of input operations including the first operation and the second operation on the touch panel 341.

The processor 21 causes the speaker 343 to output the voice guidance relating to the determination of the process function of the searched process name.

As a result, the user can easily understand the inquiry about whether or not to determine the process function of the searched process name through the ears.

Hereinabove, the embodiment of the input apparatus 1 and the control program thereof are described. However, the embodiment is not limited to this description.

In the description of the embodiment, the input apparatus 1 is an MFP. For example, the input apparatus 1 may be an information processing apparatus such as a copying machine, a self-service ordering terminal, or a self-service point of sales (POS) terminal. The self-service ordering terminal is an information processing terminal where a customer itself can order menu items in a restaurant. The self-service POS terminal is a full-self-service settlement terminal where a customer itself can perform operations from registration of purchased commodities to settlement thereof in a retail store such as a supermarket.

In the description of the embodiment, the character is a hiragana character. For example, the character may be an alphabet. In the case of an alphabet, for example, a braille character representing the alphabet and a braille character representing a hiragana character are distinguished from each other by attaching a braille representing a foreign character mark to the front of the braille character representing the alphabet or by surrounding the braille character representing the alphabet with a braille representing a foreign character quotation mark.

In the description of the embodiment, the braille file 241 is a data file in which a hiragana character, the numbers of dots corresponding to dotted protrusions, the numbers of dots not corresponding to dotted protrusions are correlated with each other and stored. For example, the braille file 241 may be a data file in which a hiragana character and the numbers of dots corresponding to dotted protrusions are correlated with each other and stored or may be a data file in which a hiragana character and the numbers of dots not corresponding to dotted protrusions are correlated with each other and stored. For example, the braille file 241 may be a data file in which a hiragana character and an image representing 6-dot Braille are correlated with each other and stored.

In the description of the embodiment, the process name table 242 is a data table configured with a process name and a first character. For example, the process name table 242 may be configured with a process name and a character correlated with the process name. That is, the first character does not need to be used. For example, the user may set a character correlated with the name of the process function in advance. For example, the process name table 242 may be configured with a process name, a character correlated with the process name, and an image representing 6-dot Braille representing the character.

In the description of the embodiment, in ACT 2 of FIG. 6, the processor 21 determines whether or not the braille input function button is touched. For example, in ACT 2, the processor 21 may wait for receiving a predetermined operation input from the user. The predetermined operation input is, for example, an operation input if the user inputs an operation by performing a predetermined touch input operation on the home screen. The predetermined touch input operation is an operation for instructing to touch the braille input function button.

In the description of the embodiment, in ACT 21 of FIG. 7, the processor 21 identifies the braille character based on the numbers stored in the first memory 361 and the second memory 362 of the non-volatile memory 36. For example, the processor 21 may identify the braille character based on the numbers stored in the first memory 361 or may identify the braille character based on the numbers stored in the second memory 362.

In the description of the embodiment, the non-volatile memory 36 includes the first memory 361 and the second memory 362. For example, the non-volatile memory 36 may include any one of the first memory 361 or the second memory 362.

For example, if the non-volatile memory 36 includes only the first memory 361, the process of ACT 11 of FIG. 6 is removed. In ACT 21 of FIG. 7, the processor 21 identifies the braille character based on the numbers stored in the first memory 361.

For example, if the non-volatile memory 36 includes only the second memory 362, the process of ACT 10 of FIG. 6 is removed. In ACT 21 of FIG. 7, the processor 21 identifies the braille character based on the numbers stored in the second memory 362.

In the description of the embodiment, the processor 21 proceeds to ACT 3 of FIG. 6 after causing the speaker 343 to output the error notification in ACT 24 of FIG. 7. For example, the processor 21 may proceed to ACT 1 after causing the speaker 343 to output the error notification. In this case, the error notification may be, for example, the content that notifies that the process function cannot be found based on the input braille character, the content that notifies that the home screen is displayed again, or the like.

In the description of the embodiment, the first operation is an operation for giving an instruction that a dot configuring a braille character corresponds to a dotted protrusion, and the second operation is an operation for giving an instruction that the dot configuring the braille character does not correspond to a dotted protrusion. For example, the first operation may be an operation for giving an instruction that a dot configuring a braille character does not correspond to a dotted protrusion, and the second operation may be an operation for giving an instruction that the dot configuring the braille character corresponds to a dotted protrusion.

In the description of the embodiment, the first operation is the tap operation on the n-th braille input screen displayed on the touch panel 341, and the second operation is the swipe operation on the n-th braille input screen displayed on the touch panel 341. The first operation is not limited to the tap operation. The second operation is not limited to the swipe operation. The first operation and the second operation only need to be different touch input operations. For example, the user may set the first operation and the second operation in advance.

In the description of the embodiment, the second operation is an operation of confirming whether or not the dot configuring the braille character corresponds to a dotted protrusion and is also an operation for giving an instruction that the dot configuring the braille character does not correspond to a dotted protrusion. The operation of confirming whether or not the dot configuring the braille character corresponds to a dotted protrusion is not limited to the second operation. For example, if any one of the first input through the first operation or the second input through the second operation is received on the n-th braille input screen, the processor 21 may confirm whether or not the dot configuring the braille character corresponds to a dotted protrusion. The first operation is an operation for giving an instruction that a dot configuring a braille character corresponds to a dotted protrusion and is also an operation of confirming whether or not the dot configuring the braille character corresponds to a dotted protrusion. In this case, the process of ACT 9 of FIG. 6 is removed.

In the description of the embodiment, if the execution input is received through the execution operation, the processor 21 executes the process of the determined process function. For example, if the determination input is received through the determination operation, the processor 21 may execute the process of the determined process function. In this case, the processes of ACT 28 to ACT 30 of FIG. 7 are removed.

As a result, the process of the process function to be used is automatically executed. Therefore, the user can reduce the time and effort required for giving an instruction for various detailed settings on the setting screen, the time and effort required for performing the execution operation, and the like.

In the description of the embodiment, the swipe operation is performed consistently in the predetermined direction. For example, if the user executes the swipe operation in a direction opposite to the predetermined direction on the n-th braille input screen, the processor 21 may display an (n−1)-th braille input screen.

In this case, the user may perform the cancellation operation on the (n−1)-th braille input screen and perform the first input through the first operation and the second input through the second operation, or the second input through the second operation again. The cancellation operation is an operation for allowing the user to cancel the instruction of whether or not the dot configuring the braille character corresponds to a dotted protrusion on the (n−1)-th braille input screen. The cancellation operation may be, for example, a touch input operation. In addition, the processor 21 may cause the speaker 343 to output the voice guidance. The voice guidance is, for example, “The operation input performed on the (n−1)-th braille input screen is cancelled. Please input an operation again.”

For example, the user may perform a confirmation operation on the (n−1)-th braille input screen. The confirmation operation is an operation for allowing the user to confirm whether or not the dot configuring the braille character on the (n−1)-th braille input screen corresponds to a dotted protrusion. The confirmation operation may be, for example, a touch input operation. In addition, the processor 21 may cause the speaker 343 to output the voice guidance. The voice guidance is, for example, “The dot configuring the braille character on the (n−1)-th braille input screen corresponds to a dotted protrusion,” or “The dot configuring the braille character on the (n−1)-th braille input screen does not correspond to a dotted protrusion.”

If the swipe operation is performed in a direction opposite to the predetermined direction on the first braille input screen, the screen cannot be moved. Therefore, the processor 21 maintains the state where the first braille input screen is displayed.

In the description of the embodiment, the process name of the process name table 242 and the first character have a one-to-one relationship. For example, the same first character may be set for a plurality of process names.

If a plurality of process names correlated with the hiragana character acquired in the process of ACT 23 of FIG. 7 are present, the processor 21 may cause the touch panel 341 to display process function buttons of the plurality of corresponding process names in ACT 25. For example, the processor 21 may cause the touch panel 341 to display the home screen, may enable the process function buttons of the plurality of corresponding process names, and may disable the process function button of the non-corresponding process name. In addition, the processor 21 may cause the speaker 343 to output the voice guidance. The voice guidance is, for example, the content that notifies that the plurality of corresponding process functions are present or the content that urges the user to select one process function among the plurality of corresponding process functions. The voice guidance is, for example, “To select the first process function candidate, please touch the button ‘1.’ To select the second process function candidate, please touch the button ‘2.’” or “To select the first process function candidate, please perform the tap operation on the touch panel. To select the second process function candidate, please perform the double tap operation on the touch panel”.

The program that is executed by the processor 21 of the input apparatus 1 according to the embodiment is provided by being recorded in a computer-readable storage medium such as a compact disc read-only memory (CD-ROM), a flexible disk, a compact disc-recordable (CD-R), or a digital versatile disk (DVD) in a file format that is installable or executable in the data memory 24. In addition, the program that is executed by the processor 21 according to the embodiment may be provided or distributed through a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An input apparatus comprising:
a touch panel configured to receive a first input of giving a first instruction that a dot configuring a braille character corresponds to a dotted protrusion through a first operation and a second input of giving a second instruction different from the first instruction of the first input through a second operation different from the first operation; and
a processor configured to identify the braille character based on the first input and the second input received by the touch panel and searches for one or more process functions corresponding to the braille character identified by the processor.

2. The apparatus of claim 1, wherein
when the processor receives the second input, the processor confirms whether or not the dot configuring the braille character corresponds to the dotted protrusion, and
when a number of times the processor confirms whether or not the dot configuring the braille character corresponds to the dotted protrusion reaches a predetermined number of times, the processor identifies the braille character.

3. The apparatus of claim 1, further comprising a display configured to display a process function result of the one or more process functions searched by the processor.

4. The apparatus of claim 3, further comprising a speaker configured to output a voice guidance relating to a determination of the one or more process functions searched by the processor.

5. The apparatus of claim 1, wherein the braille character is a hiragana character, an alphabet, a numerical character, or a character of a language.

6. The apparatus of claim 1, further comprising
a scanner configured to perform a first process function of the one or more process functions, the first process function comprising a scanning function, and
a printer configured to perform a second process function of the one or more process functions, the second process function comprising a printing function.

7. The apparatus of claim 1, wherein the second instruction is that the dot configuring the braille character does not correspond to the dotted protrusion.

8. The apparatus of claim 1, wherein
the first operation is a tap operation, a double tap operation, a long tap operation, a swipe operation, a pinch out operation, or a pinch in operation, and
the second operation is a tap operation, a double tap operation, a long tap operation, a swipe operation, a pinch out operation, or a pinch in operation.

9. The apparatus of claim 1, wherein the braille character has a one-to-one relationship with a process name of one of the one or more process functions.

10. The apparatus of claim 1, wherein the braille character is correlated with a plurality of process names, each of the plurality of process names of one of the one or more process functions.

11. A control method of an input apparatus comprising:
receiving a first input of giving a first instruction that a dot configuring a braille character corresponds to a dotted protrusion through a first operation and a second input of giving a second instruction different from the first instruction of the first input through a second operation different from the first operation;
identifying the braille character based on the first input and the second input that are received; and
searching for one or more process functions corresponding to the braille character identified.

12. The method of claim 11, further comprising confirming whether or not the dot configuring the braille character corresponds to the dotted protrusion when the second input is received, and wherein identifying the braille character occurs when a number of times confirming whether or not the dot configuring the braille character corresponds to the dotted protrusion reaches a predetermined number of times.

13. The method of claim 11, further comprising displaying a process function result of the one or more process functions searched.

14. The method of claim 13, further comprising outputting a voice guidance relating to a determination of the one or more process functions searched.

15. The method of claim 11, wherein the braille character is a hiragana character, an alphabet, a numerical character, or a character of a language.

16. The method of claim 11, wherein a first process function of the one or more process functions comprises a scanning function, and a second process function of the one or more process functions comprises a printing function.

17. The method of claim 11, wherein the second instruction is that the dot configuring the braille character does not correspond to the dotted protrusion.

18. The method of claim 11, wherein
the first operation is a tap operation, a double tap operation, a long tap operation, a swipe operation, a pinch out operation, or a pinch in operation, and
the second operation is a tap operation, a double tap operation, a long tap operation, a swipe operation, a pinch out operation, or a pinch in operation.

19. The method of claim 11, wherein the braille character has a one-to-one relationship with a process name of one of the one or more process functions.

20. The method of claim 11, wherein the braille character is correlated with a plurality of process names, each of the plurality of process names of one of the one or more process functions.
